(19) United States
(12) Patent Application Publication
(10) Pub. No.: US 2025/0381637 A1
(43) Pub. Date: Dec. 18, 2025

(54) METHOD FOR OPERATING A PIVOT DRIVE AND PIVOT DRIVE

(71) Applicant: WEISS GMBH, Buchen (DE)

(72) Inventor: Arnold HORN, Hardheim-Erfeld (DE)

(21) Appl. No.: 18/880,769

(22) PCT Filed: Jun. 2, 2023
(86) PCT No.: PCT/EP2023/064780

§ 371 Date: Jan. 2, 2025

(30) Foreign Application Priority Data
Jul. 5, 2022 (DE) 102022116653.8

(51) Int. Cl. B23Q 16/10; F16D 66/00; F16D 121/22

(52) U.S. Cl. CPC B23Q 16/102; F16D 66/00; B23Q 2210/004; F16D 2121/22

(57) ABSTRACT

The present invention relates to a method for operating a pivot drive, in particular a rotary indexing table, comprising an output element that can be driven to make a rotational movement, in particular a turntable, and an electrically actuatable braking device for braking and/or fixing the output element, wherein a time development of at least one characteristic parameter of the energization of the braking device is determined during an actuation of the braking device and a state of the braking device is determined on the basis of an analysis of the time development of the characteristic parameter. A corresponding pivot drive is further described.

The invention relates to a method for operating a pivot drive, in particular a rotary indexing table, comprising an output element that can be driven to make a rotational movement, in particular a turntable, and an electrically actuatable braking device for braking and/or fixing the output element.

Pivot drives of this kind are widely used in particular in industrial production. For example, rotary indexing tables are widely used, inter alia in assembly technology and automation technology. Workpieces are, for example, arranged on a turntable of such rotary indexing tables. During the machining and/or assembly of said workpieces, the turntable is set into continuous or cycled rotational movements, for instance to be able to machine the workpieces from different directions. In this respect, the precision of the rotary indexing table is of special significance so that the workpiece always adopts well-defined positions/orientations relative to the assembly tools/machining tools. The precision of the apparatus results from the accuracy with which the table can adopt the individual machining positions and from the precision of the rotational movement of the table between the machining positions.

It is usually necessary to fix the turntable during an assembly or machining phase, i.e. in a phase in which the turntable is at rest. This may be necessary, for example, if particularly large forces take effect and/or the respective position must be particularly precisely maintained. For this purpose, a braking device can be provided that cooperates directly or indirectly with the output element. In other words, it is not absolutely necessary for the braking device to engage directly at the output element. It is also conceivable to achieve the fixing of the braking device via a component fixedly connected to the output element.

It may also be desirable for safety reasons to be able to ensure a reliable fixing of the output element as required.

The term braking device should be broadly understood in the context of the present invention. It can include friction-locked and/or form-fitting features with which a reliable fixing or locking of the output element in the respective desired position is ensured.

Braking devices that are suitable for pivot drives and in particular for rotary indexing tables are usually electrically actuable units that are subject to unavoidable wear. Such wear may under certain circumstances result in a less precise fixing and, in the worst case, even in a failure of the pivot drive, which can lead to downtimes in the corresponding production line.

It is therefore an object of the present invention to be able to recognize wear-related changes to the braking device at an early stage and to be able to avoid associated problems in advance.

This object is satisfied by a method having the features of claim 1.

According to the invention, a time development of at least one characteristic parameter of the energization of the braking device is determined during an actuation of the braking device and a state of the braking device is determined on the basis of an analysis of the time development of the characteristic parameter. If changes are recognized during this analysis, it can be concluded that the state of the braking device has changed. The analysis is preferably carried out continuously or at regular or irregular intervals, for example during each release process of the braking device. A high time density of the analyses enables a more precise detection of the state change of the braking device.

For the sake of completeness, it is pointed out that a determination of a time development of the characteristic parameter can mean that said parameter is measured continuously or at discrete points in time. Suitable sampling rates are preferably selected to be able to perform the analysis with the required accuracy.

The principle according to the invention can be applied to a wide variety of kinds of braking devices, for example to safety brakes, holding brakes and/or service brakes.

One advantage of the method according to the invention is that parameters of the energization of the braking device can be easily determined. A high design effort and/or control technology effort is not required to implement the method. In many cases, already existing components can even be used, i.e. additional sensor components are usually not required. It is also by all means conceivable to determine and analyze a plurality of parameters of the energization in order to obtain an even more accurate impression of the state of the braking device.

According to one embodiment, the braking device is designed such that it is opened by an energization. Or to put it another way: In this embodiment, the output element is fixed when no energization of the braking device takes place. This design is also advantageous from a safety point of view in many cases since a reliable fixing of the output element takes place automatically in the event of a power failure. For example, the drive device has a braking element that is acted on by spring force and that can be brought into an open state against the spring force by means of an electromagnet (“releasing the braking device”). However, the principle according to the invention can also be applied to a permanent magnetic brake.

The characteristic parameter whose time development is determined can be a current intensity. However, it is also possible to observe the time development of the voltage or other parameters.

According to one embodiment of the method, the analysis comprises a determination of a local maximum or a local minimum and/or of a characteristic change in the time development of the characteristic parameter, in particular wherein the local maximum and/or the local minimum and/or the characteristic change are interpreted as an indication of a complete opening of the braking device.

For example, such an indication can be a brief drop in the observed characteristic parameter, for example the current intensity. Such a drop in an otherwise continuous increase in the current intensity during the energization of the braking device leads to the formation of a local maximum in the development of the specific parameter that is followed by a local minimum since the current intensity increases again in the further course of the activation of the braking device. The curve of the current intensity thus shows a characteristic change that allows conclusions to be drawn about the state of the braking device.

The physical effect that leads to the brief drop in the current intensity (“current dip”) can be, for example, an armature of the electromechanical part of the braking device abutting a corresponding magnetic part. The braking device is only completely open from this moment onward. Ultimately, this is a case of a stroke of a braking element away from the output element or from a component connected thereto. In a new state of the braking device, this stroke, also called an air gap, is a well-defined value, namely the nominal air gap width. With increasing wear, the air gap to be overcome changes; it becomes wider.

According to one embodiment of the method, a characteristic duration of a predefined part of the actuation of the braking device is therefore used as a measure for the state of the braking device, in particular wherein the duration of the predefined part of the actuation is determined by means of the analysis. The characteristic duration in this case is the time period that is required to overcome the air gap.

The characteristic duration is in particular determined by determining a time period from a start of the energization of the braking device up to a local maximum or local minimum and/or up to a characteristic change in the time development of the characteristic parameter. A temporal classification of these extremes or of the occurrence of the characteristic change thus makes it possible to recognize (at least qualitatively or even quantitatively) whether its width has changed or even how wide the air gap now is.

According to a further embodiment of the method, the characteristic duration is compared with a nominal duration and a correction signal and/or a warning signal is/are output if a nominal duration is fallen below and/or exceeded. A correction signal can, for example, serve to compensate an increased air gap width, for instance through changes in the energization pattern. A warning signal can be of an acoustic and/or visual nature to alert the operator to a certain state of the braking device. A corresponding warning scheme can be multi-stage. It is also possible to transmit a corresponding warning signal in an automated manner (e.g. via a wired or wireless data network), for example to immediately request maintenance when a certain state is recognized.

An operational reliability of the pivot drive is further improved if a drive of the output element is controlled in dependence on the state of the braking device. In particular, the drive of the output element is only activated when it is recognized that the braking device is completely open. To ensure this in a particularly reliable manner, a predetermined delay interval or a delay interval determined in dependence on the state of the braking device can be provided, by which delay interval an activation of the drive of the output element is delayed after a complete opening of the braking device has been detected. The delay interval can be a fixed value. However, it is also possible for the delay interval to be adapted to the state of the braking device. For example, a longer delay interval can be selected if the braking device is already exposed to some wear in order to achieve a greater operational reliability.

The delay interval is thus a kind of “safety pause” between the recognized complete opening of the braking device and the start of the movement of the output element. The wear of the braking system can thereby be minimized.

It is generally also conceivable that the determined opening durations of the braking device are averaged over a certain time period and the activation of the drive is then adjusted accordingly.

The present invention further relates to a pivot drive, in particular a rotary indexing table, comprising an output element that can be driven to make a rotational movement, in particular a turntable, an electrically actuatable braking device for braking and/or fixing the output element, and a control unit for controlling a drive of the output element and/or the braking device, said control unit being configured and adapted to perform a method according to at least one of the above-described embodiments.

Further embodiments of the invention are set forth in the claims, in the description and in the enclosed drawings. The invention will be explained in the following purely by way of example with reference to an embodiment of the invention. There are shown:

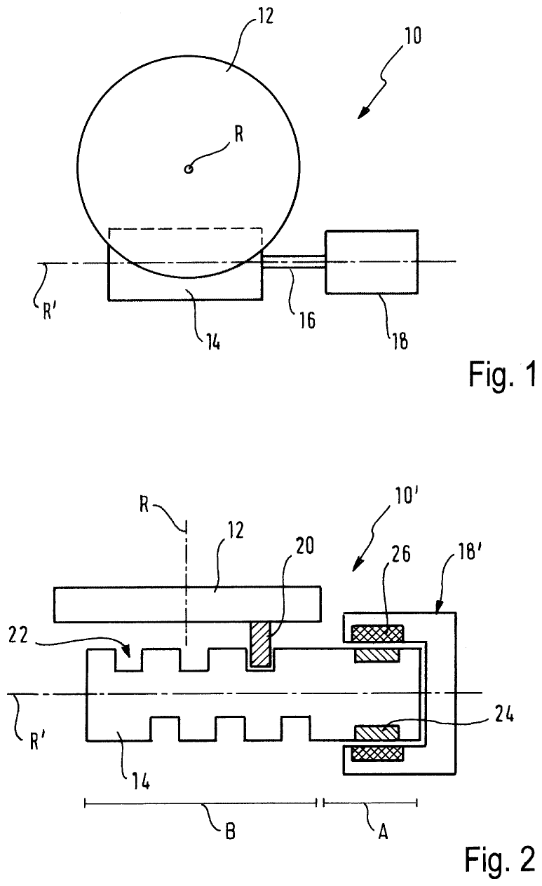

FIG. 1 an embodiment of a rotary indexing table;

FIG. 2 a cross-section through a further embodiment of a rotary indexing table;

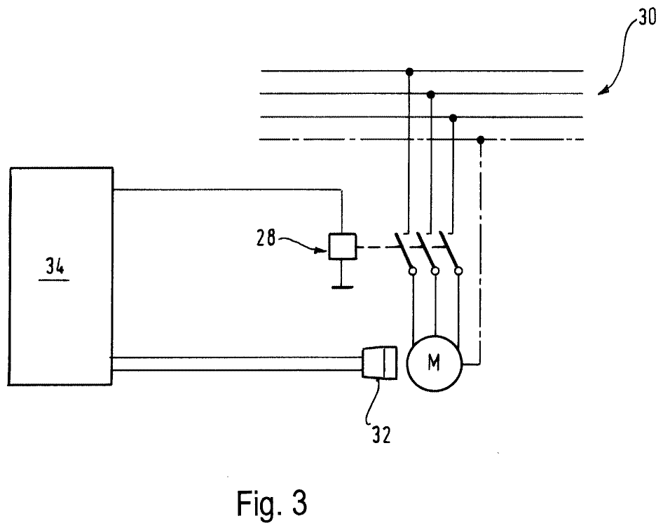

FIG. 3 a schematic circuit diagram of a rotary indexing table; and

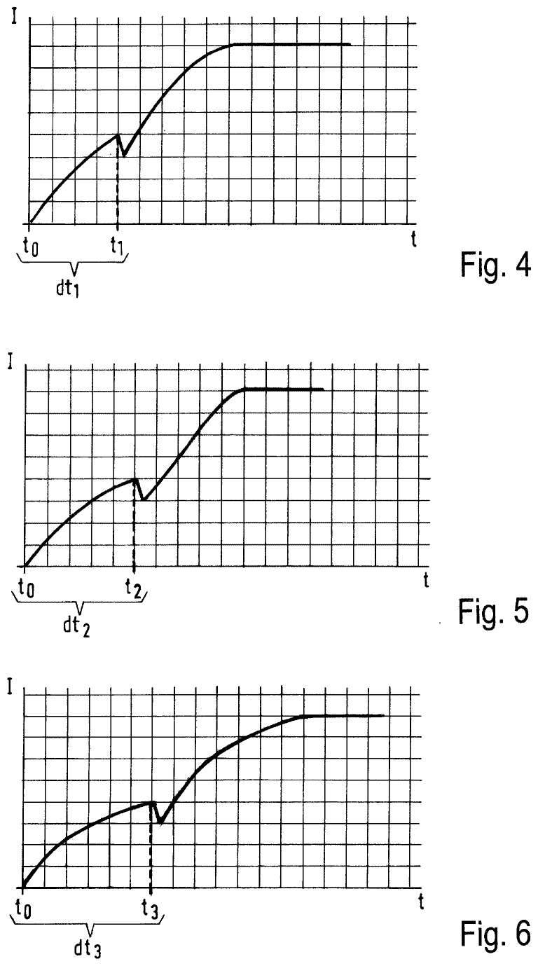

FIGS. 4 to 6 the time development of the current intensity during the energization of the braking device in various states.

FIG. 1 schematically shows, purely by way of example, a rotary indexing table 10 that has a turntable 12 on which workpieces can be clamped for machining and/or assembly. The turntable 12 is driven by a barrel cam 14 to make a rotational movement about an axis of rotation R that extends perpendicular to the image plane. To transmit a drive movement of the barrel cam 14, which is a rotation of the barrel cam 14 about an axis of rotation R′ perpendicular to the axis of rotation R, to the turntable 12, said turntable has entrainers (not shown in FIG. 1, see entrainer 20 in FIG. 2) that engage in a form known per se into a drive groove (not shown in FIG. 1, see drive groove 22 in FIG. 2) having a constant or varying pitch and running spirally around the barrel cam 14. The drive groove can have one or more latch threads.

The barrel cam 14 is rotationally fixedly connected to a drive shaft 16. The drive shaft 16 is simultaneously the output shaft of a motor 18 that is, for example, electrically driven.

In the rotary indexing table 10, the barrel cam 14 and the motor 18 are coaxially arranged, i.e. both the motor 18 and the drive shaft 16 as well as the barrel cam 14 rotate about the common axis of rotation R during operation.

It can be seen from FIG. 1 that the drive of the barrel cam 14 takes place in a direct manner, i.e. without a gear connected between the motor 18 and the barrel cam 14. Only the drive shaft 16 is provided to transmit a drive torque between the two components mentioned. If required, however, a gear and/or a drive belt can also be provided between the motor 18 and the barrel cam 14.

In principle, any motor, such as an asynchronous motor or a synchronous motor, can be used as the motor 18.

FIG. 2 shows a cross-section through a further embodiment 10′ of the rotary indexing table. It can be recognized in the left-hand part of the drawing how an entrainer 20 of the turntable 12 engages into a drive groove 22 of the barrel cam 14. The representation of this known drive concept is only shown in highly simplified form.

The right-hand part of FIG. 2 comprises the drive components of the barrel cam 14. In contrast to the embodiment shown in FIG. 1, the drive of the rotary indexing table 10′ does not have a drive shaft 16. Rather, the barrel cam 14 itself forms a part of the motor 18′ that is configured as a torque motor. The barrel cam 14 has, at an extension section A, (electro) magnets 24 that cooperate with coils 26 of the torque motor 18′. In other words, the extension section A is the rotor of the torque motor 18′ that is directly connected to a section B of the barrel cam 14 that does not have the drive groove 22. The sections A, B are consequently integral components of the barrel cam 14. The section B of the barrel cam 14 can—relative to the extension section A—also be called an extension of the rotor of the torque motor 18′. The extension section A substantially has the same diameter as the section B of the barrel cam 14 provided with the drive groove 22.

The embodiment of the drive of the rotary indexing table 10′ schematically shown in FIG. 2 is characterized by a compact design and a precise drive of the barrel cam 14. Expensive gear elements subject to friction/play are not used.

FIG. 3 shows a simplified circuit diagram for controlling a rotary indexing table that is not shown in this Figure for the sake of simplicity. The motor M of said rotary indexing table (see, for example, motors 18, 18′ in FIGS. 1 and 2) is connected to a three-phase alternating current network 30 via a motor contactor 28. The contactor 28 ensures that an energization of the motor M only takes place when a brake 32 is completely open or released.

The brake 32 is of an electromechanical design and serves to fix the turntable 12 as required. As initially described, said brake cooperates directly or indirectly with the turntable 12. In the present embodiment example, the brake 32 must be energized to open it against a preload force that secures a closed state of the brake 32. The opening movement is caused by the force of an electromagnet, for example.

The brake 32 is subject to wear so that its complete opening or release requires a larger stroke as the operating duration increases. According to the invention, it is therefore proposed to determine the wear of the brake 32 by analyzing a time development of a characteristic parameter of the energization during the opening of the brake 32. For this purpose, the brake 32 is connected to a control unit 34 that performs the analysis of the time development of the parameter. It has proved to be expedient to observe the current consumption of the brake 32 during the opening. If the analysis of the relevant data reveals that the brake 32 is completely open, the control unit 34 sends a corresponding signal to the motor contactor 28 that then ensures an energization of the motor M. It is thereby ensured that the turntable 12 is not driven before the brake has been reliably released. To increase the operational safety, provision can be made to wait a certain amount of time after a complete opening of the brake 32 has been detected before energizing the motor M. This delay can be a fixed value. However, it is by all means conceivable to select this delay depending on the wear of the brake 32.

With reference to the curves shown in FIGS. 4 to 6, it will be explained below how the complete opening of the brake 32 is determined. The curves each show the development of the current intensity I versus time t.

FIG. 4 shows a typical development to be expected if the brake 32 has not yet been exposed to any (significant) wear. At the point in time t₀, the energization of the brake 32 starts in order to open it. The current intensity | subsequently increases until it drops briefly at a point in time t₁ (local maximum in the curve development) in order thereafter to increase again (local minimum in the curve development) and to finally reach a plateau. The above-described characteristic drop marks the point in time at which an armature of an electromagnet of the brake 32 abuts a spatially statically arranged part of the brake 32. The brake is now completely open. A duration dt₁ for opening the brake 32 is therefore defined by the point in time t₁.

The duration dt₁ thus forms a reference value. With increasing wear, the opening duration increases, as shown in FIGS. 5 and 6 (see points in time t₂ and t₃ or opening durations dt₂ and dt₃). Provision can be made that, if a threshold value of the opening duration dt is exceeded, a correction signal and/or warning signal is output in order—as already initially described—e.g. to perform an adjustment of the energization of the motor M or to issue a maintenance reminder.

The method according to the invention was described above in connection with the analysis of a time development of the current intensity and in particular with reference to a characteristic brief current drop when opening a braking device. It is understood that the underlying concept of the invention also includes the analysis of curves of other parameters and/or the observation of other characteristic properties or patterns of the corresponding curves. Furthermore, it should be noted that conventional methods for analyzing data, such as filtering and/or smoothing, can be used to make the method according to the invention more efficient.

### REFERENCE NUMERAL LIST

10, 10′ rotary indexing table
12 turntable
14 barrel cam
16 drive shaft
M, 18, 18′ motor or torque motor
20 entrainer
22 drive groove
24 magnet
26 coil
28 motor contactor
30 three-phase alternating current network
32 brake
34 control unit
R, R′ axis of rotation
A extension section
B groove section
I current intensity
t time
t₁, t₂, t₃ point in time
dt₁, dt₂, dt₃ opening duration
Max local maximum
Min local minimum

1-11. (canceled)

12. A method for operating a pivot drive, comprising an output element that can be driven to make a rotational movement, and an electrically actuatable braking device for braking and/or fixing the output element,
wherein a time development of at least one characteristic parameter of the energization of the braking device is determined during an actuation of the braking device and a state of the braking device is determined on the basis of an analysis of the time development of the characteristic parameter.

13. The method according to claim 12,
wherein the braking device is designed such that it is opened by an energization.

14. The apparatus according to claim 12,
wherein the characteristic parameter is a current intensity.

15. The method according to claim 12,
wherein the analysis comprises a determination of a local maximum or a local minimum and/or of a characteristic change in the time development of the characteristic parameter.

16. The method according to claim 12,
wherein a characteristic duration of a predefined part of the actuation of the braking device is used as a measure for the state of the braking device.

17. The method according to claim 16,
wherein the characteristic duration is determined by determining a time period from the start of the energization up to a local maximum or local minimum and/or up to a characteristic change in the time development of the characteristic parameter.

18. The method according to claim 16,
wherein the characteristic duration is compared with a nominal duration and a correction signal and/or a warning signal is/are output if a nominal duration is fallen below and/or exceeded.

19. The method according to claim 12,
wherein a drive of the output element is controlled in dependence on the state of the braking device.

20. The method according to claim 12,
wherein a drive of the output element is only activated if it is recognized that the braking device is completely open.

21. The method according to claim 19,
wherein a predetermined delay interval or a delay interval determined in dependence on the state of the braking device is provided, by which delay interval an activation of the drive of the output element is delayed after a complete opening of the braking device has been detected.

22. A pivot drive, comprising an output element that can be driven to make a rotational movement, an electrically actuatable braking device for braking and/or fixing the output element, and a control unit for controlling a drive of the output element and/or the braking device, said control unit being configured and adapted to perform a method operating the pivot drive, in which method a time development of at least one characteristic parameter of the energization of the braking device is determined during an actuation of the braking device and a state of the braking device is determined on the basis of an analysis of the time development of the characteristic parameter.

23. The method according to claim 12,
wherein the pivot drive is a rotary indexing table.

24. The method according to claim 12,
wherein the output element can be driven to make a rotational movement of a turntable.

25. The method according to claim 15,
wherein the local maximum and/or the local minimum and/or the characteristic change are interpreted as an indication of a complete opening of the braking device.

26. The method according to claim 16,
wherein the duration of the predefined part of the actuation is determined by means of the analysis.

27. The pivot drive according to claim 22,
that is a rotary indexing table.

28. The pivot drive according to claim 22,
wherein the output element is part of a turntable.
